(19) United States
(12) Patent Application Publication
(10) Pub. No.: US 2025/0175406 A1
(43) Pub. Date: May 29, 2025

(54) METHOD AND APPARATUS FOR COMPENSATING LONG PROPAGATION DELAY IN A NON-TERRESTRIAL NETWORK

(71) Applicant: Electronics and Telecommunications Research Institute, Daejeon (KR)

(72) Inventors: Jae Seung LEE, Daejeon (KR); Mi Young YUN, Daejeon (KR); Seungkwon CHO, Daejeon (KR); Moon-sik LEE, Daejeon (KR); Jun Hwan LEE, Daejeon (KR)

(21) Appl. No.: 18/963,403

(22) Filed: Nov. 27, 2024

(30) Foreign Application Priority Data
Nov. 29, 2023 (KR) 10-2023-0169880

(51) Int. Cl. H04L 43/0864; H04B 7/185

(52) U.S. Cl. CPC H04L 43/0864; H04B 7/18513

(57) ABSTRACT

Disclosed are a method and an apparatus for compensating for a long propagation delay in a non-terrestrial network. A method of a terminal may comprise: transmitting first data to a base station through a satellite; starting a data inactivity timer that expires after a first time period elapses from a time of transmitting the first data; and determining a first round trip time (RTT) between the terminal and the base station before the first time period elapses, wherein the data inactivity timer is configured in the terminal so that an operating state of the terminal transitions to an idle state.

### CROSS-REFERENCE TO RELATED APPLICATIONS

This application claims priority to Korean Patent Application No. 10-2023-0169880, filed on Nov. 29, 2023, with the Korean Intellectual Property Office (KIPO), the entire contents of which are hereby incorporated by reference.

### BACKGROUND

### 1. Technical Field

The present disclosure relates to a non-terrestrial network technique, and more particularly, to a technique of compensating for a long propagation delay in a non-terrestrial network.

### 2. Related Art

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a FR1 and/or FR2 band. Compared to the LTE communication network, the 5G communication network can support various communication services and scenarios.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

A communication network (e.g. 5G communication network, 6G communication network, etc.) can provide communication services to terminals located on the ground. In addition to the terminals located on the ground, a demand for communication services for non-terrestrial entities such as airplanes, drones, and satellites is increasing, and technologies for non-terrestrial networks (NTNs) are being discussed to meet this demand. The NTNs can be implemented based on 5G communication technology, 6G communication technology, and the like. For example, in an NTN, communication between a satellite and communication nodes located on the ground or communication between communication nodes (e.g. airplanes, drones, etc.) located in non-terrestrial regions can be performed based on the 5G communication technology, 6G communication technology, and the like. In the NTN, the satellite can perform functions of a base station in a communication network (e.g. 5G communication network, 6G communication network, etc.).

In the NTN, signals transmitted and received through a link between a terminal and the satellite (hereinafter referred to as a ‘service link’) or a link between the satellite and a gateway (hereinafter referred to as a ‘feeder link’) may experience long distances. In the NTN, propagation delays may occur in the service link or the feeder link. The propagation delay occurring in the NTN may be greater than that occurring in a conventional terrestrial network (TN). NTN cells formed in the NTN may move according to the movement of the satellite. A radius of an NTN cell may be larger than that of a cell formed in a TN. Therefore, a timing relationship between uplink and downlink, which is applied in a TN, may not be applicable in an NTN. A method for compensating for a propagation delay, taking into account the timing relationship between uplink and downlink in an NTN, may be required.

### SUMMARY

The present disclosure for resolving the above-described problems is directed to providing a method and an apparatus for compensating for a propagation delay in a non-terrestrial network.

A method of a terminal, according to exemplary embodiments of the present disclosure for achieving the above-described objective, may comprise: transmitting first data to a base station through a satellite; starting a data inactivity timer that expires after a first time period elapses from a time of transmitting the first data; and determining a first round trip time (RTT) between the terminal and the base station before the first time period elapses, wherein the data inactivity timer may be configured in the terminal so that an operating state of the terminal transitions to an idle state.

The first RTT may be determined based on at least one of a second RTT between the terminal and the satellite, a third RTT between the satellite and a reference point, or a fourth RTT between the reference point and the base station.

The method may further comprise: receiving information related to the fourth RTT from the base station, before determining the first RTT.

The method may further comprise: performing a monitoring operation for receiving second data from the base station through the satellite during a second time period that is a sum of the first time period and the first RTT.

When the second data is not received from the base station during the second time period, the operating state of the terminal may transition to an idle state.

The method may further comprise: restarting the data inactivity timer, when the second data is received from the base station during the second time period.

The method may further comprise: transmitting third data to the base station before the second time period elapses; and restarting the data inactivity timer after transmitting the third data.

The method may further comprise: receiving information related to the third RTT from the base station, before determining the first RTT; and assuming a type of the satellite based on the information related to the third RTT, wherein the type of the satellite may be one of a transparent type or a regenerative type.

A method of a base station, according to exemplary embodiments of the present disclosure for achieving the above-described objective, may comprise: receiving, from a terminal that has started a data inactivity timer, first data through a satellite; assuming a time of receiving the first data as a start time of the data inactivity timer; and determining a first round trip time (RTT) between the terminal and the base station, wherein the data inactivity timer may be assumed by the base station to expire after a first time period elapses from the time of receiving the first data.

The method may further comprise: assuming that an operating state of the terminal has transitioned to an idle state, when second data is not transmitted to the terminal before a second time period elapses from the time of receiving the first data, the second time period being a sum of the first time period and the first RTT.

The method may further comprise: assuming that the terminal has restarted the data inactivity timer, when second data is transmitted to the terminal before the first time period elapses from the time of receiving the first data.

The method may further comprise: receiving third data from the terminal before a second time period elapses from the time of receiving the first data, the second time period being a sum of the first time period and the first RTT; and assuming that the terminal has restarted the data inactivity timer after receiving the third data.

The method may further comprise: before the receiving of the first data, transmitting, in a broadcast manner, at least one of ephemeris information of the satellite, information related to a third RTT between the satellite and a reference point, or information related to a fourth RTT between the reference point and the base station.

The method may further comprise: in response to assuming that the operating state of the terminal has transitioned to an idle state, resetting one or more radio resource control (RRC) parameters for the terminal.

The first RTT may be determined based on at least one of a second RTT between the terminal and the satellite, a third RTT between the satellite and a reference point, or a fourth RTT between the reference point and the base station.

The method may further comprise: causing the terminal to assume a type of the satellite based on the information related to the third RTT transmitted in the broadcast manner, wherein the type of the satellite may be one of a transparent type or a regenerative type.

A terminal, according to exemplary embodiments of the present disclosure for achieving the above-described objective, may comprise: at least one processor, wherein the at least one processor causes the terminal to perform: transmitting first data to a base station through a satellite; starting a data inactivity timer that expires after a first time period elapses from a time of transmitting the first data; and determining a first round trip time (RTT) between the terminal and the base station before the first time period elapses, wherein the data inactivity timer may be configured in the terminal so that an operating state of the terminal transitions to an idle state.

The first RTT may be determined based on at least one of a second RTT between the terminal and the satellite, a third RTT between the satellite and a reference point, or a fourth RTT between the reference point and the base station.

The at least one processor may further cause the terminal to perform: receiving information related to the fourth RTT from the base station, before determining the first RTT.

The at least one processor may further cause the terminal to perform: performing a monitoring operation for receiving second data from the base station through the satellite during a second time period that is a sum of the first time period and the first RTT.

According to the present disclosure, a terminal may transmit data to a base station via a satellite. When the terminal transmits data, the terminal may start a data inactivity timer. The terminal may determine a round trip time (RTT) between the terminal and a base station based on parameters. The terminal may perform a monitoring operation to receive data from the base station for a time period corresponding to a sum of a time set to the data inactivity timer and the RTT between the terminal and the base station. If the terminal fails to detect data received from the base station, the terminal may enter an idle state. If the terminal detects data received from the base station, the terminal may restart the data inactivity timer. Through the above-described procedure, a unique terminal-to-base station RTT may be established for each terminal within a non-terrestrial network (NTN) cell. By establishing a unique RTT for each terminal, a transmission and reception timing difference caused by a long propagation delay in the NTN can be addressed without modifying existing protocols.

### BRIEF DESCRIPTION OF DRAWINGS

FIG. 1 is a conceptual diagram illustrating exemplary embodiments of a non-terrestrial network.

FIG. 2 is a conceptual diagram illustrating exemplary embodiments of a non-terrestrial network.

FIG. 3 is a block diagram illustrating exemplary embodiments of an entity constituting a non-terrestrial network.

FIG. 4 is a conceptual diagram illustrating exemplary embodiments of a non-terrestrial network.

FIG. 5 is a conceptual diagram illustrating exemplary embodiments of a non-terrestrial network.

FIG. 6 is a conceptual diagram illustrating exemplary embodiments of a non-terrestrial network.

FIG. 7 is a conceptual diagram illustrating exemplary embodiments of a timing difference between downlink and uplink radio frames in a terrestrial network.

FIG. 8 is a conceptual diagram illustrating exemplary embodiments of round-trip time (RTT) in a non-terrestrial network.

FIG. 9 is a conceptual diagram illustrating exemplary embodiments of a timing difference between downlink and uplink radio frames in a non-terrestrial network.

FIG. 10A is a timing diagram illustrating exemplary embodiments of a method for transmitting and receiving data between a base station and a terminal, which is configured with a data inactivity timer.

FIG. 10B is a timing diagram illustrating exemplary embodiments of a method for transmitting and receiving data between a base station and a terminal, which is configured with a data inactivity timer.

FIG. 11A is a timing diagram illustrating exemplary embodiments of a method for transmitting and receiving data between a base station and a terminal, which is configured with a data inactivity timer.

FIG. 11B is a timing diagram illustrating exemplary embodiments of a method for transmitting and receiving data between a base station and a terminal, which is configured with a data inactivity timer.

FIG. 12 is a conceptual diagram illustrating exemplary embodiments of a non-terrestrial network in which a method for compensating propagation delay using RTT is applied.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system may include at least one of a terrestrial network, a non-terrestrial network, a 4G communication network (e.g. Long-Term Evolution (LTE) communication network), a 5G communication network (e.g. New Radio (NR) communication network), or a 6G communication network. Each of the 4G communication network, 5G communication network, and 6G communication network may include a terrestrial network and/or a non-terrestrial network. The non-terrestrial network may operate based on at least one communication technology among LTE communication technology, 5G communication technology, or 6G communication technology. The non-terrestrial network may provide communication services in various frequency bands.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

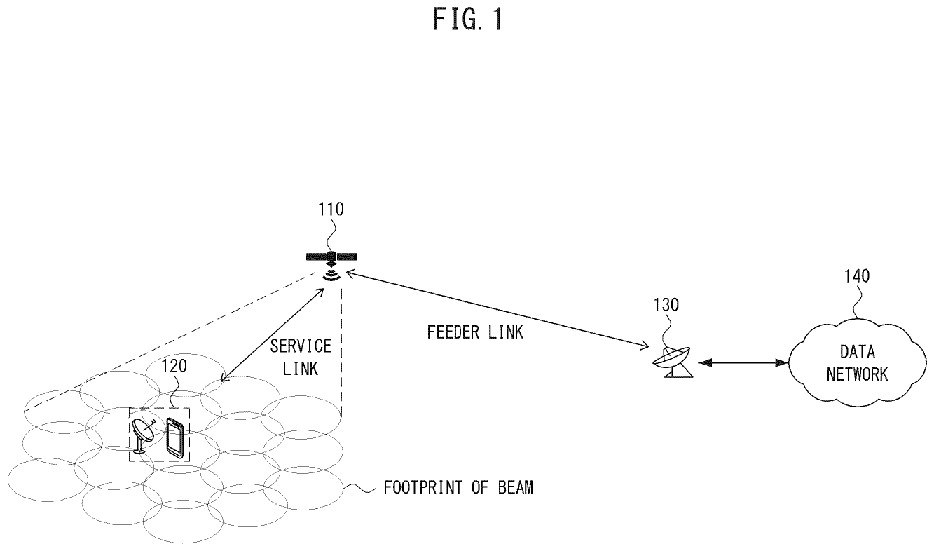

FIG. 1 is a conceptual diagram illustrating exemplary embodiments of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The satellite 110 may refer to a unmanned aerial vehicle (UAV) or a UAV base station (UBS).

The communication node 120 may include a communication node (e.g. a user equipment (UE), a terminal, or Internet of Things (IoT) device) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

A large distance between the satellite 110 and the communication node 120 may result in significantly higher propagation delay compared to terrestrial networks. If the satellite moves at high speeds, such as in the case of LEO satellite, substantial variations in propagation delay may occur. The propagation delay may depend on an elevation angle of the satellite, which is located at an altitude of 300 km to 2000 km, and may range from a minimum of 1.00 ms to 6.76 ms when the elevation angle is 90°, to a maximum of 3.87 ms to 14.78 ms when the elevation angle is 10° or 170°. The propagation delay based on the satellite's altitude and distance may be shown in Table 1 below.

TABLE 1

| | Minimum distance | | Maximum distance | |
|---|---|---|---|---|
| | (elevation angle 90) | | (elevation angle 10°or 170) | |
| Satellite | | One-way | | One-way |
| altitude | distance | propagation | distance | propagation |
| (km) | (km) | delay (ms) | (km) | delay (ms) |
| 300 | 300 | 1.00 | 1160 | 3.87 |
| 600 | 600 | 2.00 | 1932 | 6.44 |
| 900 | 900 | 3.00 | 2568 | 8.56 |
| 1000 | 1000 | 3.33 | 2762 | 9.21 |
| 1200 | 1200 | 4.00 | 3131 | 10.44 |
| 1500 | 1500 | 5.00 | 3646 | 12.15 |
| 2000 | 2000 | 6.67 | 4435 | 14.78 |

Since the satellite 110 moves at a high speed, a time during which the satellite is able to provide services to a specific location on the ground may be limited. For example, an LEO satellite located at an altitude of 600 km is able to provide wireless communication service to a specific location on the ground for approximately 500 seconds.

To inform the characteristics of the high-speed moving satellite to the terminal, the base station may broadcast ephemeris information and serviceable time of the satellite 110. The 3^{rd} generation partnership project (3GPP) specifies that the base station broadcasts the satellite's ephemeris information element and serviceable time (i.e. t-service information element) using a system information block 19 (SIB19).

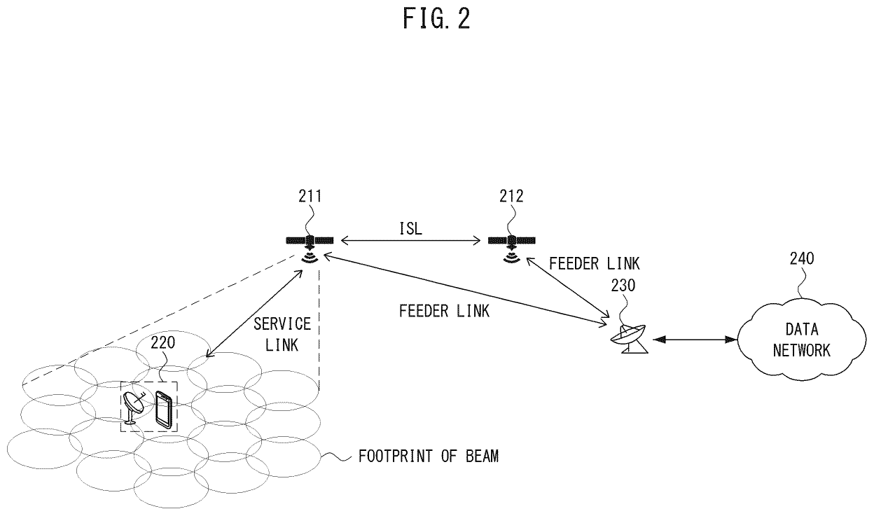

FIG. 2 is a conceptual diagram illustrating exemplary embodiments of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

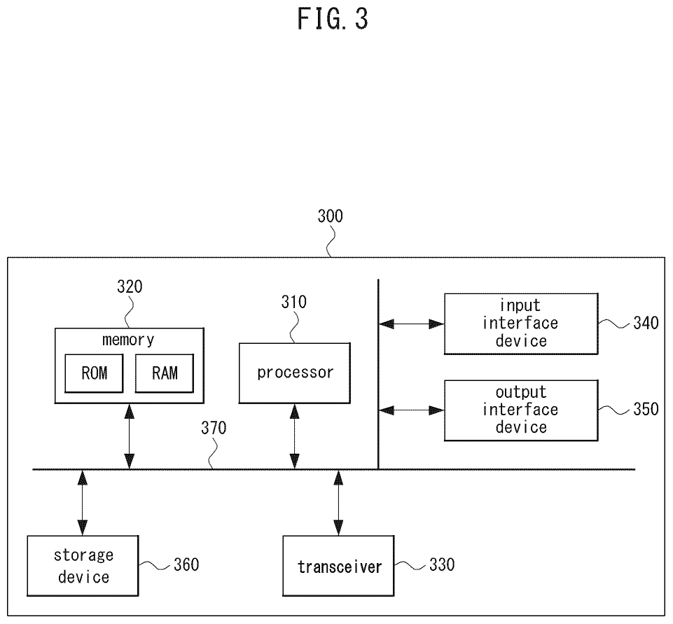

FIG. 3 is a block diagram illustrating exemplary embodiments of an entity constituting a non-terrestrial network.

Referring to FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, NTN reference scenarios may be defined as shown in Table 2 below.

TABLE 2

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’.

Parameters for the NTN reference scenarios defined in Table 2 may be defined as shown in Table 3 below.

TABLE 3

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the minimum | | |
| elevation angle | | |
| Maximum round trip delay | Scenario A: 541.46 ms (service | Scenario C: (transparent |
| (RTD) | and feeder links) | payload: service and feeder |
| (only propagation delay) | Scenario B: 270.73 ms (only | links) |
| | service link) | 25.77 ms (altitude of 600 km) |
| | | 41.77 ms (altitude of 1,200 km) |
| | | Scenario D: (regenerative |
| | | payload: only service link) |
| | | 12.89 ms (altitude of 600 km) |
| | | 20.89 ms (altitude of 1,200 km) |
| Maximum delay variation | 16 ms | 4.44 ms (altitude of 600 km) |
| within a single beam | | 6.44 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the NTN reference scenarios defined in Table 2, delay constraints may be defined as shown in Table 4 below.

TABLE 4

| | Scenario A | Scenario B | Scenario C1-2 | Scenario D1-2 |
|---|---|---|---|---|
| Satellite altitude | 35,786 km | | 600 km | |
| Maximum RTD in a radio | 541.75 ms | 270.57 ms | 28.41 ms | 12.88 ms |
| interface between base | (worst case) | | | |
| station and UE | | | | |
| Minimum RTD in a radio | 477.14 ms | 238.57 ms | 8 ms | 4 ms |
| interface between base | | | | |
| station and UE | | | | |

Hereinafter, methods of transmitting and receiving data using a satellite group in a communication system will be described. Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a terminal is described, a base station corresponding thereto may perform an operation corresponding to the operation of the terminal. Conversely, when an operation of a base station is described, a corresponding terminal may perform an operation corresponding to the operation of the base station. In a mobile communication system, a terminal may be in a radio resource control (RRC) idle mode, RRC inactive mode, or RRC connected mode, depending on its traffic activity. When the terminal is in the RRC idle mode, a core network may not possess context information of the terminal. Therefore, the terminal in the RRC idle mode may perform terminal-based mobility-related procedures, such as cell selection or cell reselection, without receiving commands from the core network.

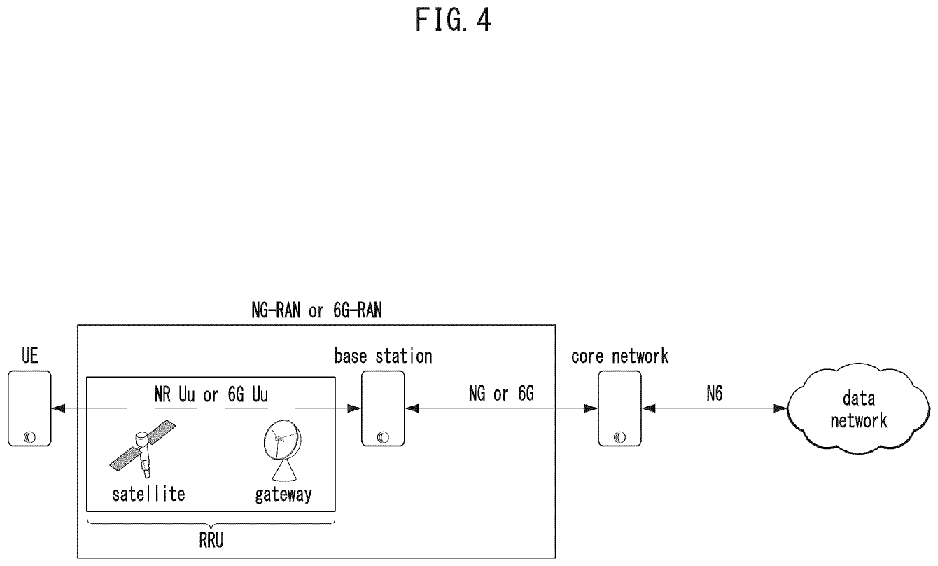

FIG. 4 is a conceptual diagram illustrating exemplary embodiments of a non-terrestrial network.

Referring to FIG. 4, a satellite may be a transparent satellite. The satellite may serve as a radio frequency (RF) repeater. The satellite may perform frequency conversion operations. A gateway may deliver signals transmitted through an NR-Uu interface to a base station. The NR-Uu interface may be applied to both a service link and a feeder link. The satellite and gateway may function as a radio unit of a base station.

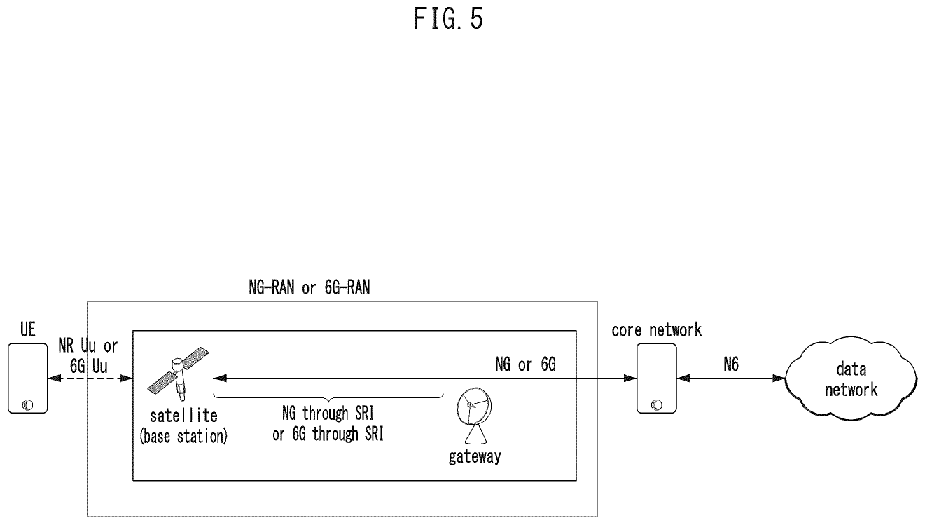

FIG. 5 is a conceptual diagram illustrating exemplary embodiments of a non-terrestrial network.

Referring to FIG. 5, a satellite may be a regenerative satellite. The satellite may serve as a base station. An NR-Uu interface may be applied between a terminal and the base station. A satellite radio interface (SRI) may be applied to a feeder link. On the feeder link, an NG protocol may be transmitted through the SRI. When multiple satellites are overhead, communication between the satellites may be performed through inter-satellite links (ISL). A gateway may serve as a transport network layer (TNL) node and may relay between the satellite base station and a core network using transport protocols.

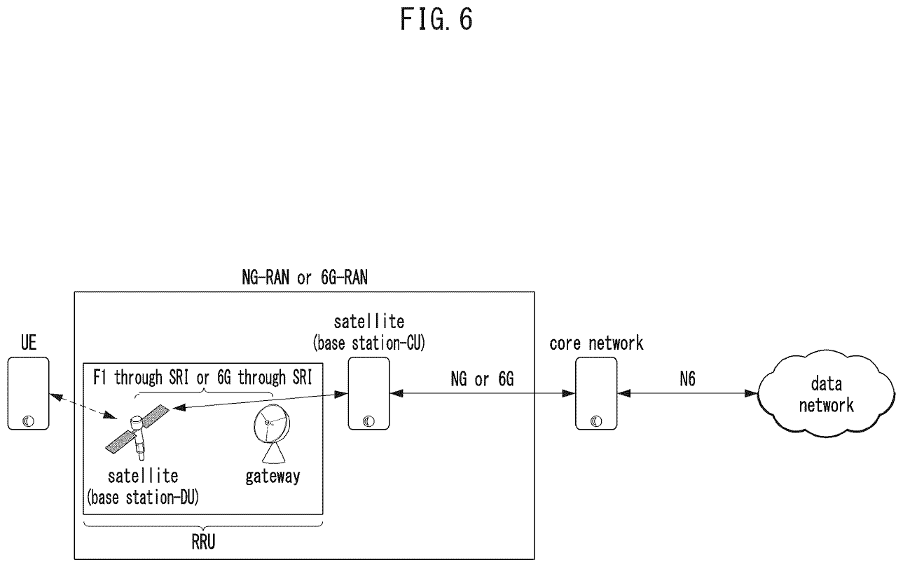

FIG. 6 is a conceptual diagram illustrating exemplary embodiments of a non-terrestrial network.

Referring to FIG. 6, a satellite may perform functions of a distributed unit (DU), which are part of a base station's functions. Functions of a central unit (CU) may be performed by a base station located on the ground. DUs located on different satellites may be connected to a single CU located on the ground.

An NR-Uu interface may be applied between the satellite and a terminal. An SRI may be applied to a feeder link. On the feeder link, an F1 protocol may be transmitted through the SRI. A gateway may serve as a TNL node and may relay between the satellite DU and the ground CU using transport protocols.

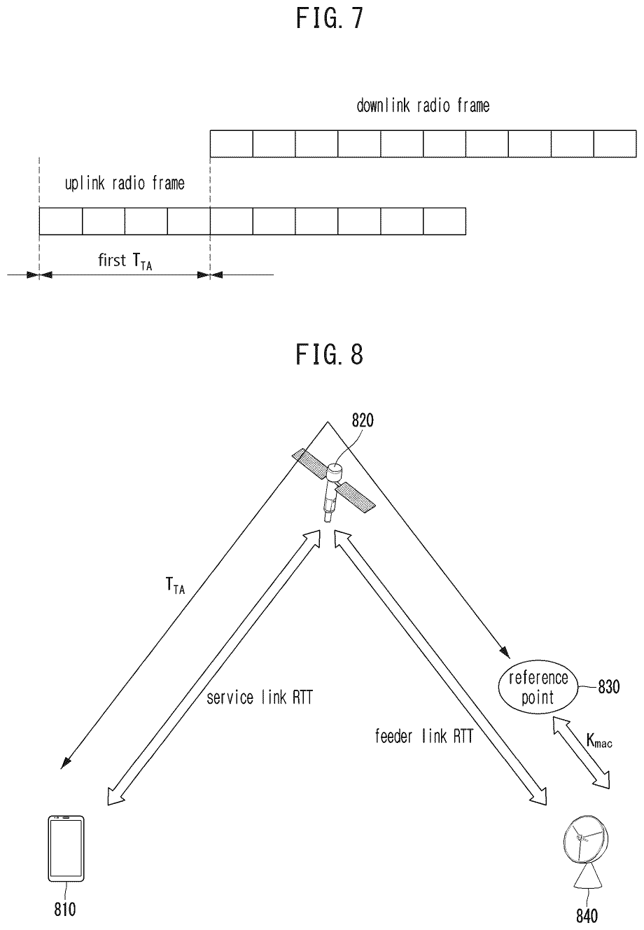

FIG. 7 is a conceptual diagram illustrating exemplary embodiments of a timing difference between downlink and uplink radio frames in a terrestrial network.

Referring to FIG. 7, meaning of a timing advance (TA) will be described below. A TA procedure may refer to a procedure of adjusting a transmission timing of each terminal's signal so that, when each terminal transmits the signal to the base station, the signal is received at the base station at a correct timing. Therefore, each terminal may perform uplink transmission (e.g. transmission of an uplink radio frame and/or uplink subframe) earlier by a first T_{TA} than a time at which the terminal starts receiving a downlink radio frame.

FIG. 8 is a conceptual diagram illustrating exemplary embodiments of round-trip time (RTT) in a non-terrestrial network.

Referring to FIG. 8, a non-terrestrial network may include a terminal 810, a satellite 820, a reference point 830, and a gateway 840. The reference point 830 may refer to a point located between the satellite 820 and the gateway 840. The reference point 830 may be located at the satellite 820 or at the base station. Transmission and reception timings of uplink and downlink radio frames may be aligned at the reference point 830. The gateway 840 may connect the non-terrestrial network and a terrestrial network.

A service link may be established between the terminal 810 and the satellite 820. A feeder link may be established between the satellite 820 and the gateway 840. Since the satellite 820 is located at a high altitude, a round trip time (RTT) of the service link and an RTT of the feeder link may be significantly large. A significant propagation delay may occur between the terminal 810 and the base station. An extended timing relationship proposed to compensate for the propagation delay will be described below.

In a terrestrial network, an equation for calculating a TA may be as shown in Equation 1 below. N_{TA} and N_{TA,offset} may refer to parameters used to calculate the TA. N_{TA} may be configured by a message 2 or message B when the terminal 810 performs a random access procedure with the base station. Once N_{TA} is configured, N_{TA} may be updated by a medium access control (MAC) control element (CE). N_{TA,offset} may refer to a fixed offset. T_{c} may refer to a basic time unit in NR.

$${T}_{TA} = ( {N}_{TA} + {N}_{TA , offset} ) {T}_{c} \qquad [ Equation 1 ]$$

In a non-terrestrial network (NTN), a method for calculating a TA may be as shown in Equation 2 below. N_{TA,adj}^{common} may be referred to as a common TA. Once N_{TA,adj}^{common} is determined, an RTT between the satellite 820 and the reference point 830 may also be determined. N_{TA,adj}^{common} may be used to pre-compensate for the RTT between the satellite 820 and the reference point 830. N_{TA,adj}^{common} may be a value commonly applied to all terminals connected to the satellite 820. N_{TA,adj}^{common} and the RTT between the satellite 820 and the reference point 830 may be calculated based on at least one of TaCommon, TaCommonDrift, or TACommonDriftVariation. TaCommon, TaCommonDrift, or TACommonDriftVariation may be configured by the base station. The base station may transmit, to the terminal, information indicating TaCommon, TaCommonDrift, or TACommonDriftVariation. In an NTN including the regenerative satellite 820, the terminal 810 may consider N_{TA,adj}^{common} to be 0.

The terminal 810 may receive an information element indicating a value of N_{TA,adj}^{common} from the base station through the satellite 820. Using the received information element, the terminal may identify that N_{TA,adj}^{common} is set to a value less than or equal to 0. Upon identifying that N_{TA,adj}^{common} is set to a value less than or equal to 0, the terminal 810 may assume that the satellite 820 is a regenerative satellite rather than a transparent satellite. The base station may cause the terminal to assume whether the satellite 820 is of a transparent type or a regenerative type depending on whether the value of N_{TA,adj}^{common} is greater than 0 or less than or equal to 0. By assuming the type of satellite based on whether N_{TA,adj}^{common} is less than or equal to 0, the base station may omit a procedure of broadcasting an information element indicating the type of the satellite 820.

When it is allowed for the reference point to be located on a transparent satellite, the value of N_{TA,adj}^{common} may be 0 even if the satellite is of a transparent type. When it is allowed for the reference point to be located on a transparent satellite, the base station may cause the terminal to assume whether the satellite 820 is of a transparent type or a regenerative type depending on common whether the value of N_{TA,adj}^{common}, which is indicated by an information element transmitted to the terminal through the satellite 820, is greater than or equal to 0 or less than 0. In the case of a regenerative satellite, the value of N_{TA,adj}^{common} may be set to a value less than 0.

N_{TA,adj}^{UE} may be referred to as a UE-specific TA. Once N_{TA,adj}^{UE} is determined, an RTT of the service link between the terminal 810 and the satellite 820 may also be determined. N_{TA,adj}^{UE} may be used to pre-compensate for the RTT of the service link between the terminal 810 and the satellite 820. The base station may broadcast ephemeris information of the satellite 820 or parameter(s) related to a common TA for a serving cell. The terminal 810 may receive the ephemeris information of the satellite 820 from the base station. The terminal 810 may determine a location of the terminal 810 using a global navigation satellite system (GNSS). The terminal 810 may determine N_{TA,adj}^{UE} and the RTT between the terminal 810 and the reference point 830 based on the ephemeris information of the satellite 820 or location information of the terminal 810, either before connecting to the NTN cell or while connected to the NTN cell.

$${T}_{TA} = ( {N}_{TA} + {N}_{TA , offset} + {N}_{TA , adj}^{common} + {N}_{TA , adj}^{UE} ) {T}_{c} \qquad [ Equation 2 ]$$

The terminal 810 may continuously update the TA in the RRC connected state. The terminal 810 may be configured to report the TA to the base station during a random access procedure or in the RRC connected state.

K_{offset} may be introduced to ensure that the terminal 810 secures a sufficient time to process data before transmitting uplink data after receiving downlink data. K_{offset} may be referred to as a configured scheduling offset. K_{offset} may be set to a value equal to or greater than a sum of the service link RTT and the common TA. The terminal 810 may shift a slot for transmitting a physical uplink shared channel (PUSCH) by K_{offset} compared to the conventional timing after receiving downlink control information (DCI) scheduling the PUSCH. When the terminal 810 initially performs a random access procedure, the terminal 810 may obtain a cell-specific K_{offset} from system information broadcast by the base station. After performing the random access procedure, the terminal 810 may obtain the UE-specific K_{offset} through a MAC CE received from the base station. The terminal 810 may update the previous K_{offset} using the obtained K_{offset}.

K_{mac} may be referred to as a configured offset. K_{mac} may be used to calculate the RTT between the terminal 810 and the base station. K_{mac} may be the same as the RTT between the reference point 830 and the base station. K_{mac} may be used to delay an application time of configurations indicated by a MAC CE received by the terminal 810 from the base station through a PDSCH. K_{mac} may be a value provided by the base station to the terminal 810 when timings of downlink and uplink radio frames are not aligned at the base station. The terminal 810 may obtain K_{mac} from system information broadcast by the base station. If the base station does not provide K_{mac} to the terminal 810, the terminal 810 may assume K_{mac} to be 0. An equation for calculating the RTT between the terminal 810 and the base station using T_{TA} and K_{mac} may be as shown in Equation 3 below.

$$UE - gNB RTT = {T}_{TA} + {K}_{mac} = ( {N}_{TA} + {N}_{TA , offset} + {N}_{TA , adj}^{common} + {N}_{TA , adj}^{UE} ) {T}_{c} + {K}_{m a c} \qquad [ Equation 3 ]$$

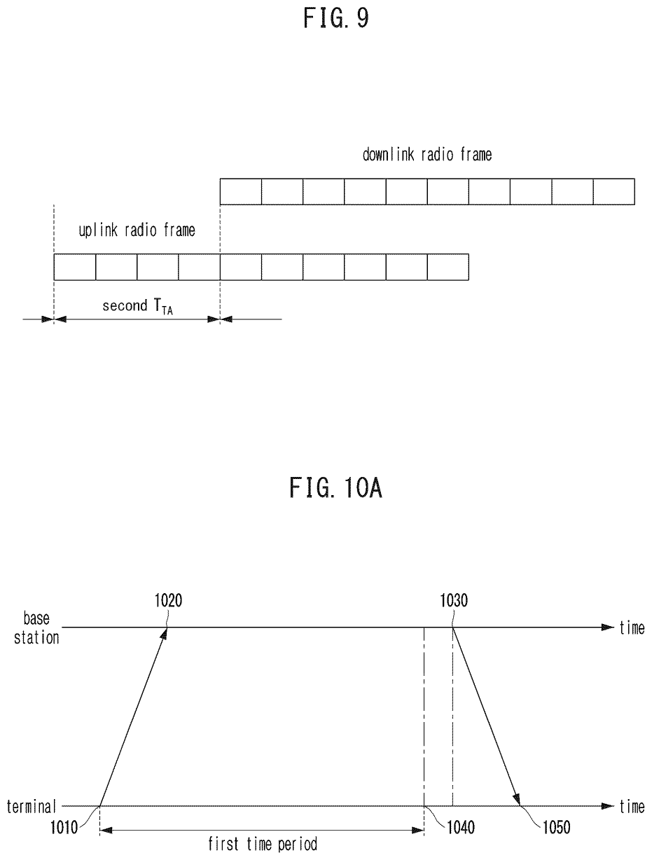

FIG. 9 is a conceptual diagram illustrating exemplary embodiments of a timing difference between downlink and uplink radio frames in a non-terrestrial network.

Referring to FIG. 9, a second T_{TA} in FIG. 9, which is to compensate for a propagation delay occurring in the NTN, may differ from the first T_{TA} in FIG. 7. The first T_{TA} in FIG. 7 may be calculated as shown in Equation 1. The second T_{TA} in FIG. 9 may be calculated as shown in Equation 2.

In the NTN, a significantly larger propagation delay may occur compared to a terrestrial network. Unlike a terrestrial network, cells in the NTN may move, and thereof radii may be very large. Therefore, enhancements to the protocols used in NR may be required.

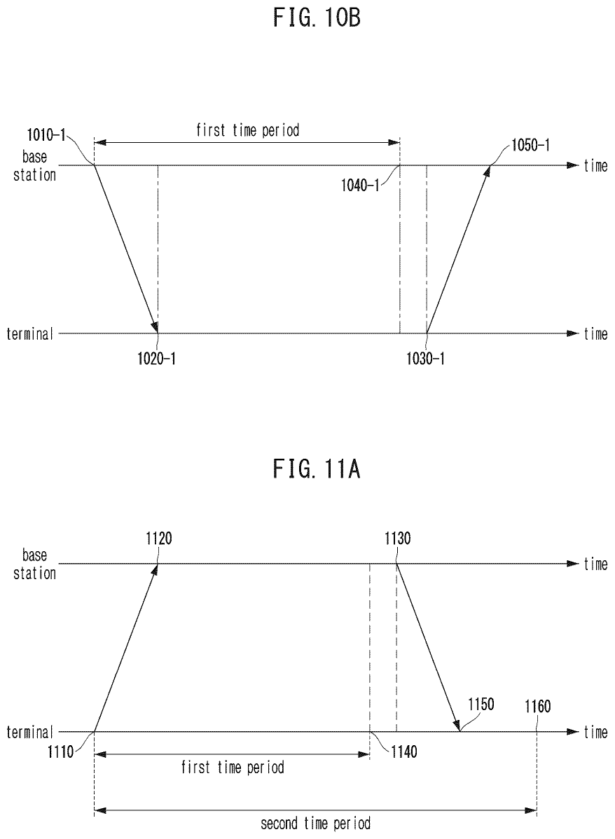

FIG. 10A is a timing diagram illustrating exemplary embodiments of a method for transmitting and receiving data between a base station and a terminal, which is configured with a data inactivity timer.

Referring to FIG. 10A, a data inactivity timer may be configured for a terminal so that the terminal transitions to an idle state, even if a base station does not explicitly instruct the terminal to release an RRC connection. While the terminal is in an RRC connected state, there may be no data transmission or reception for a predetermined period. When no data transmission or reception occurs during the predetermined period, the data inactivity timer may expire. Upon expiration of the data inactivity timer, the terminal may autonomously transition to the idle state. In order for the terminal in the idle state to resume data transmission and reception, RRC reconfiguration may need to be performed for the terminal. Hereinafter, a procedure for transmitting and receiving data between the terminal and the base station using the data inactivity timer will be described.

When the terminal is in the RRC connected state, an RRC layer of the base station may configure the data inactivity timer in the terminal. The RRC layer of the base station may control the terminal's data inactivity operations using the data inactivity timer. When the data inactivity timer is configured in the terminal, the terminal's MAC layer may start or restart the data inactivity timer when receiving or transmitting data. The terminal's MAC layer receiving data refers to receiving a MAC service data unit (SDU) through a dedicated traffic channel (DTCH), dedicated control channel (DCCH), common control channel (CCCH), or multicast traffic channel (MTCH). The terminal's MAC layer transmitting data refers to the MAC layer transmitting a MAC SDU through a DTCH or DCCH.

If the data inactivity timer expires due to the prolonged absence of data being received or transmitted by the terminal, the terminal's MAC layer may notify the expiration of the data inactivity timer to an upper layer of the terminal. Once the terminal's upper layer is informed of the data inactivity timer's expiration, the terminal may reset the MAC layer. After resetting the MAC layer, the terminal may transition to the idle state. In order for the terminal in the idle state to resume data transmission and reception, an RRC setup procedure may need to be performed again.

The above-described procedure for data transmission and reception between the terminal and the base station using the data inactivity timer may function without issues in terrestrial networks. However, in non-terrestrial networks, such procedure may encounter issues due to long propagation delays. Hereinafter, the issues of using the data inactivity timer for data transmission and reception between the terminal and the base station in non-terrestrial networks will be described.

At a time 1010, the terminal may transmit first data to the base station through an uplink. At the time 1010, the terminal may start a data inactivity timer. From the time 1010, the terminal may perform a monitoring operation to receive second data from the base station during a first time period corresponding to a time set to the data inactivity timer. The base station may receive the first data from the terminal at a time 1020. Due to a long propagation delay, a difference between the time 1010 and time 1020 may be significant. The base station may assume that the time 1020 is a time when the terminal starts the data inactivity timer. At a time 1040, the data inactivity timer of the terminal may expire. At the time 1040, the terminal may transition to the idle state. The base station may assume that the terminal's data inactivity timer expires after the first time period elapses from the time 1020.

The base station may transmit the second data to the terminal through a downlink at the time 1030, a time after the terminal's data inactivity timer has already expired. A difference between the time 1030 and time 1020 may be shorter than the first time period. The base station may assume that the terminal restarts the data inactivity timer at the time 1030. However, since the data inactivity timer of the terminal has already expired at the time 1050 when the second data reaches the terminal, the terminal, having transitioned to the idle state, may fail to receive the data transmitted by the base station. To resume data transmission and reception, the terminal that has transitioned to the idle state may need to perform the RRC setup procedure again. The overhead required for data reception, caused by the RRC setup procedure, may be significantly large. Therefore, improvements are needed for the procedure of data transmission and reception between the terminal and the base station using the data inactivity timer in non-terrestrial networks.

FIG. 10B is a timing diagram illustrating exemplary embodiments of a method for transmitting and receiving data between a base station and a terminal, which is configured with a data inactivity timer.

Referring to FIG. 10B, a base station may transmit first data to a terminal through a downlink at a time 1010-1. The base station may assume that the time 1010-1 is a time when the terminal starts a data inactivity timer. From the time 1010-1, the base station may perform a monitoring operation to receive second data from the terminal during a first time period corresponding to a time set to the data inactivity timer. The terminal may receive the first data from the base station at a time 1020-1. Due to a long propagation delay, a difference between the time 1010-1 and time 1020-1 may be significant. At the time 1020-1, the terminal may start the data inactivity timer. The base station may assume that the terminal's data inactivity timer expires at a time 1040-1. The base station may assume that the terminal transitions to the idle state at the time 1040-1, and may perform RRC connection release or RRC parameter initialization for the terminal.

After the first time period elapses from the time 1020-1, the terminal's data inactivity timer may expire. At a time 1030-1, which is after the base station releases the RRC connection for the terminal, the terminal may transmit the second data to the base station through an uplink. A difference between the time 1030-1 and time 1020-1 may be shorter than the first time period. At the time 1030-1, the terminal may restart the data inactivity timer. Since the base station has already performed the RRC connection release or RRC parameter initialization for the terminal at the time 1040-1, the base station may fail to receive the second data transmitted by the terminal at the time 1050-1 when the second data reaches the base station. In order for the terminal to resume data transmission and reception, the RRC setup procedure may need to be performed again. Performing the RRC setup procedure may result in significant overhead for data transmission. Therefore, improvements are needed for the procedure of data transmission and reception between the terminal and the base station using the data inactivity timer in non-terrestrial networks.

The time period required for the expiration of the data inactivity timer may not be configured individually for terminals connected to the satellite. The value of the data inactivity timer may be configured for each cell group. The data inactivity timer value may be defined by MAC-CellGroupConfig of RRC parameters as shown in Tables 5 and 6 below. When the RRC parameter containing the data inactivity timer value is configured, the same data inactivity timer value may be set for all cells belonging to the cell group. Consequently, an issue may arise in that the data inactivity timer value cannot be configured differently for each cell. Such an issue may also occur in the scenarios presented in FIG. 10A or FIG. 10B.

TABLE 5

| -- ASN1START | | |
|---|---|---|
| -- TAG-MAC-CELLGROUPCONFIG-START | | |
| MAC-CellGroupConfig ::= | SEQUENCE { | |
| drx-Config | SetupRelease { DRX-Config } | OPTIONAL, |
| -- Need M | | |
| schedulingRequestConfig | SchedulingRequestConfig | OPTIONAL, |
| -- Need M | | |
| bsr-Config | BSR-Config | OPTIONAL, -- |
| Need M | | |
| tag-Config | TAG-Config | OPTIONAL, -- |
| Need M | | |
| phr-Config | SetupRelease { PHR-Config } | OPTIONAL, |
| -- Need M | | |
| skipUplinkTxDynamic | BOOLEAN, | |
| ..., | | |
| [[ | | |
| csi-Mask | BOOLEAN | OPTIONAL, -- |
| Need M | | |
| dataInactivityTimer | SetupRelease { DataInactivityTimer } | OPTIONAL |
| -- Cond MCG-Only | | |
| ]], | | |
| [[ | | |
| usePreBSR-r16 | ENUMERATED {true} | OPTIONAL, |
| -- Need R | | |
| schedulingRequestID-LBT-SCell-r16 | | SchedulingRequestId |
| OPTIONAL, -- Need R | | |
| lch-BasedPrioritization-r16 | ENUMERATED {enabled} | OPTIONAL, |

| | |
|---|---|
| -- Need R | |
| schedulingRequestID-BFR-SCell-r16 | Scheduling RequestId |
| OPTIONAL, -- Need R | |

| | |
|---|---|
| drx-ConfigSecondaryGroup-r16 | SetupRelease { DRX-ConfigSecondaryGroup } |

OPTIONAL -- Need M
]],

```
TABLE 6
      [[
        enhancedSkipUplinkTxDynamic-r16 ENUMERATED {true}
OPTIONAL, -- Need R
        enhancedSkipUplinkTxConfigured-r16 ENUMERATED {true}
OPTIONAL -- Need R
        ]],
        [[
```

| | | |
|---|---|---|
| intraCG-Prioritization-r17 | ENUMERATED {enabled} | OPTIONAL, -- |

| Cond LCH-PrioWithReTxTimer | | |
|---|---|---|
| drx-ConfigSL-r17 | SetupRelease { DRX-ConfigSL-r17 } | OPTIONAL, -- |

| Need M | | |
|---|---|---|
| drx-ConfigExt-v1700 | SetupRelease { DRX-ConfigExt-v1700 } | OPTIONAL, |

| -- Need M | | |
|---|---|---|
| schedulingRequestID-BFR-r17 | SchedulingRequestId | OPTIONAL, -- |
| Need R | | |

| | | |
|---|---|---|
| schedulingRequestID-BFR2-r17 | SchedulingRequestId | OPTIONAL, -- |
| Need R | | |
| schedulingRequestConfig-v1700 | SchedulingRequestConfig-v1700 | OPTIONAL, |

| -- Need M | | |
|---|---|---|
| tar-Config-r17 | SetupRelease { TAR-Config-r17 } | OPTIONAL, |

-- Need M

```
        g-RNTI-ConfigToAddModList-r17 SEQUENCE (SIZE (1..maxG-RNTI-r17)) OF MBS-
RNTI-SpecificConfig-r17 OPTIONAL, -- Need N
        g-RNTI-ConfigToReleaseList-r17 SEQUENCE (SIZE (1..maxG-RNTI-r17)) OF MBS-
RNTI-SpecificConfigId-r17 OPTIONAL, -- Need N
        g-CS-RNTI-ConfigToAddModList-r17 SEQUENCE (SIZE (1..maxG-CS-RNTI-r17)) OF
MBS-RNTI-SpecificConfig-r17 OPTIONAL, -- Need N
        g-CS-RNTI-ConfigToReleaseList-r17 SEQUENCE (SIZE (1..maxG-CS-RNTI-r17)) OF
MBS-RNTI-SpecificConfigId-r17 OPTIONAL, -- Need N
        allowCSI-SRS-Tx-MulticastDRX-Active-r17 BOOLEAN
    OPTIONAL -- Need M
        ]]
```

When a single base station forms multiple cells, differences in cell radii may arise. When a single base station configures TN cells and NTN cells into a single cell group, differences in radii between the cells may become very large. If the differences in radii between the cells become very large, differences in RTT between the terminals and the base station may also become very large. Additionally, in the case of NTN cells, even among terminals belonging to the same cell, the differences in RTT between the terminals and the base station may vary significantly depending on the terminals' locations. For example, since a radius of a cell formed by a GEO satellite is very large, RTT differences between the terminals and the base station may become substantial depending on the terminals' locations within the GEO cell. If a data inactivity timer value for a cell group is set based on a smaller-radius cell, terminals belonging to a larger-radius cell may frequently transition to the idle state. Conversely, if the data inactivity timer value is set based on a larger-radius cell, terminals belonging to a smaller-radius cell may transition to the idle state less frequently, even when no data is being transmitted or received. Such infrequent transition to the idle state may reduce a power-saving effect for the terminals. For terminals belonging to a larger-radius cell (e.g. a cell formed by a GEO satellite), if a data inactivity timer value is set based on a terminal with a smaller RTT to the base station, terminals with a larger RTT to the base station may frequently transition to the idle state. On the other hand, if a data inactivity timer value is set based on a terminal with a larger RTT to the base station, terminals with a smaller RTT to the base station may transition to the idle state less frequently, even when no data is being transmitted or received. Such infrequent transition to the idle state may reduce a power-saving effect for the terminals.

The time period for the data inactivity timer configured for each cell group may be configured to apply only to terminals belonging to TN cells. A time period for a new data inactivity timer for terminals belonging to NTN cells may be added to MAC-CellGroupConfig. The above-described measure can resolve some issues because terminals in TN cells and NTN cells use different time periods for data inactivity timers. However, since radius differences between NTN cells may be large and location differences among terminals within an NTN cell may also be significant, the issues may not be completely resolved. To address these issues, a method that configures an optimal data inactivity timer time period for each terminal without modifying the existing RRC parameters may be needed.

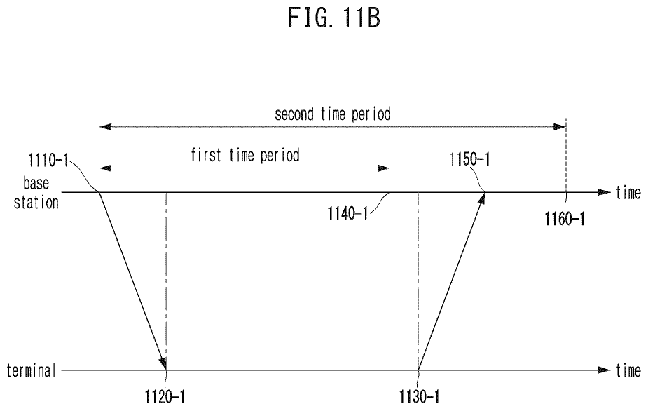

FIG. 11A is a timing diagram illustrating exemplary embodiments of a method for transmitting and receiving data between a base station and a terminal, which is configured with a data inactivity timer.

Referring to FIG. 11A, a terminal may transmit first data to a base station at a time 1110. At the time 1110, the terminal may start a data inactivity timer. From the time 1110, the terminal may perform a monitoring operation to receive second data from the base station during a second time period. The second time period may be an extended time period longer than a first time period configured for the data inactivity timer.

The base station may receive the first data from the terminal at a time 1120. The base station may assume that the terminal starts the data inactivity timer at the time 1120. The base station may assume that the terminal's data inactivity timer expires after the first time period elapses from the time 1120. The terminal's data inactivity timer may expire after the first time period elapses (e.g. at a time 1140). Even if the terminal's data inactivity timer expires after the first time period elapses (e.g. at the time 1140), the terminal may not notify the upper layer of the expiration of the data inactivity timer at the time 1140. If the terminal does not receive the second data from the base station during the second time period, the terminal may notify the upper layer of the expiration of the data inactivity timer at a time 1160.

The base station may transmit second data to the terminal through a downlink at a time 1130, which is a time after the expiration of the terminal's data inactivity timer, and the terminal may receive the second data. A difference between the time 1130 and time 1120 may be less than the first time period. The base station may assume that the terminal restarts the data inactivity timer at the time 1130. Since the fact that the terminal's data inactivity timer expires is not notified to the upper layer of the terminal at the time 1150, the terminal may not enter the idle state. Therefore, the terminal may receive the second data transmitted by the base station at the time 1150. Because the terminal receives the second data from the base station, the terminal may restart the data inactivity timer at the time 1150.

The first time period may be referred to as a ‘reception window of the terminal’. The terminal entering the idle state after the second time period elapses even though the data inactivity timer expires after the first time period elapses may be described as an extension of the reception window. The extended reception window may correspond to the second time period. Within the extended reception window, the terminal may perform a monitoring operation to receive the second data from the base station. A difference between the second time period and the first time period may be equal to an RTT between the terminal and the base station. The terminal may obtain the difference between the second time period and the first time period using Equation 3. The parameters used in Equation 3 may correspond to the most recently updated parameters before the expiration of the first time period. A transmission window of the terminal may correspond to the first time period. When the terminal transmits or receives data, the terminal may use the same data inactivity timer value as before. The terminal may continue to use the existing RRC parameters related to the inactivity timer configuration. The terminal may use a time period corresponding to a result of adding the RTT between the terminal and the base station to the data inactivity timer value as the second time period. Therefore, the extension of the reception window may eliminate a need for modifications to the existing RRC parameters.

The extended reception window may be applied to the base station. The base station may not assume that the terminal enters the idle state at the anticipated expiration time of the terminal's data inactivity timer which corresponds to a time when the first time period elapses from the time 1120. The base station may wait for data reception from the terminal for an additional period corresponding to the RTT between the terminal and the base station beyond the anticipated expiration time of the terminal's data inactivity timer. The terminal may transmit third data to the base station through the uplink after the first time period elapses but before the second time period elapses. The base station may receive the third data transmitted from the terminal. Upon receiving the third data from the terminal, the base station may assume that the terminal's data inactivity timer has been restarted. However, the base station may not perform downlink transmission to the terminal after the anticipated expiration time of the terminal's data inactivity timer.

If data reception is not monitored by the base station despite waiting for the additional period corresponding to the RTT between the terminal and the base station, the base station may assume that the terminal has entered the idle state. If the base station assumes that the terminal has entered the idle state, the base station may perform an RRC release or RRC parameter initialization procedure for the terminal. If data reception is monitored during the additional period corresponding to the RTT between the terminal and the base station, the base station may assume that the terminal has restarted the data inactivity timer. The base station may obtain the RTT between the terminal and the base station using Equation 3. The base station may determine the RTT between the terminal and the base station based on the fact that a sum of K_{offset} and K_{mac} is approximately equal to the RTT between the terminal and the base station.

FIG. 11B is a timing diagram illustrating exemplary embodiments of a method for transmitting and receiving data between a base station and a terminal, which is configured with a data inactivity timer.

Referring to FIG. 11B, an extended reception window may be applied to a base station in a manner similar to the method described with reference to FIG. 11A. The base station may transmit first data to the terminal through a downlink at a time 1110-1. The base station may assume that the terminal starts a data inactivity timer at the time 1110-1. From the time 1110-1, the base station may perform a monitoring operation to receive second data from the terminal during a second time period. The second time period may be an extended time period longer than a first time period, which corresponds to a time set to the terminal's data inactivity timer.

The terminal may receive the first data from the base station at a time 1120-1. The terminal may start the data inactivity timer at the time 1120-1. If the first time period elapses from the time 1120-1, the data inactivity timer of the terminal may expire. The base station may assume that the terminal's data inactivity timer expires at a time 1140-1, which is a time after the first time period elapses from the time 1110-1. The base station may not assume that the terminal enters the idle state at the time 1140-1, which is the time the base station anticipates the terminal's data inactivity timer to expire. The base station may not perform an RRC release or RRC parameter initialization procedure for the terminal at the time 1140-1. The base station may perform a monitoring operation to receive second data from the terminal during the second time period. If the base station does not receive second data from the terminal during the second time period, the base station may assume that the terminal entered the idle state at a time 1160-1. If the base station assumes that the terminal has entered the idle state, the base station may perform an RRC release or RRC parameter initialization procedure for the terminal.

The terminal may transmit second data to the base station through an uplink at a time 1130-1, which is after a time the base station assumes the terminal's data inactivity timer has already expired, and the base station may receive the second data. A difference between the time 1130-1 and time 1120-1 may be less than the first time period. The base station may assume that the terminal restarted the data inactivity timer at a time 1150-1. Based on the time 1150-1, the base station may not perform an RRC release or RRC parameter initialization procedure for the terminal. Accordingly, the base station may receive the second data transmitted by the terminal at the time 1150-1. The terminal may restart the data inactivity timer at the time 1130-1. Since the base station receives the second data transmitted by the terminal at the time 1150-1, the base station may assume that the terminal's data inactivity timer has been restarted.

The first time period may be referred to as a ‘reception window of the base station’. The base station may assume that the terminal's data inactivity timer expires when the first time period elapses. Nonetheless, the base station may monitor for data reception from the terminal until the second time period elapses. If no data is received during the second time period, the base station may assume that the terminal has entered the idle state. If the base station assumes that the terminal has entered the idle state, the base station may perform an RRC release or RRC parameter initialization procedure for the terminal. The above-described sequence of operations by the base station may be described as an extension of the base station's reception window.

The extended reception window of the base station may correspond to the second time period. The base station may perform a monitoring operation to receive the second data from the terminal within the extended reception window. A difference between the second time period and the first time period may be equal to the RTT between the terminal and the base station. The base station may obtain the difference between the second time period and the first time period using Equation 3. The base station may determine the RTT between the terminal and the base station based on the fact that a sum of K_{offset} and K_{mac} is approximately equal to the RTT between the terminal and the base station. The parameters used in Equation 3 may correspond to the most recently updated parameters before the expiration of the first time period. A transmission window of the base station may correspond to the first time period. When the base station transmits or receives data, the base station may use the same data inactivity timer value as before. The base station may continue to use the existing RRC parameters related to the inactivity timer configuration for the terminal. The base station may use a time period corresponding to a result of adding the RTT between the terminal and the base station to the data inactivity timer value as the second time period. Therefore, the extension of the base station's reception window may eliminate a need for modifications to the existing RRC parameters.

The extended reception window described in the FIG. 11A may similarly be applied to the terminal. The terminal may not notify the upper layer of the expiration of the data inactivity timer at the time 1130-1, which is the expiration time of the terminal's data inactivity timer, and may not enter the idle state. The time 1130-1 may be a time when the first time period elapses from the time 1120-1. The terminal may wait for data reception from the base station for an additional period corresponding to the RTT between the terminal and the base station after the expiration time of the data inactivity timer. The base station may transmit third data to the terminal through the downlink before the second time period elapses, even after the first time period elapses. The terminal may receive the third data transmitted from the base station. Upon receiving the third data transmitted from the base station, the terminal may restart the data inactivity timer. The base station may assume that the terminal's data inactivity timer has been restarted upon transmitting the third data to the terminal. However, the terminal may not perform uplink transmission to the base station after the expiration of the terminal's data inactivity timer.

If the terminal has waited for data reception from the base station for an additional period corresponding to the RTT between the terminal and the base station after the expiration time of the data inactivity timer, but no data reception is monitored, the terminal may notify the upper layer of the expiration of the data inactivity timer. The terminal that has notified the upper layer of the expiration of the data inactivity timer may enter the idle state. Similarly to the method described in FIG. 11A, the terminal may obtain the RTT between the terminal and the base station using Equation 3. The parameters used in Equation 3 may correspond to the most recently updated parameters before the expiration of the terminal's data inactivity timer.

Hereinafter, a method for extending the reception window that differs from the aforementioned window extension method will be described. A method may be proposed where an RTT between the terminal and the base station at the time the data inactivity timer is started or restarted is added to the existing data inactivity timer time period (e.g. the first time period) to configure a new time period (e.g. the second time period) as a time period of the data inactivity timer. Accordingly, the terminal may not use the method where the expiration of the data inactivity timer is not notified to the upper layer after the data inactivity timer expires. The terminal may configure the data inactivity timer, which expires after the second time period, when starting or restarting the data inactivity timer. If the second time period elapses after the data inactivity timer is started or restarted, the terminal may enter the idle state based on the expiration of the data inactivity timer. During the second time period, the terminal may perform data transmission and reception with the base station. If data transmission or reception occurs between the terminal and the base station, the terminal may restart the data inactivity timer. When the data inactivity timer is restarted, a timer value corresponding to the second time period may be configured. The above-described reception window extension method may also be applied to the base station. Each time the data inactivity timer is assumed to be started or restarted, the base station may determine the second time period. The base station may configure the second time period as the timer value for the data inactivity timer. The base station may assume that the terminal enters the idle state if the second time period elapses from the time of data reception. If the base station assumes that the terminal has entered the idle state, the base station may initialize RRC configuration parameters for the terminal. If data transmission or reception is monitored before the second time period elapses, the base station may assume that the terminal has restarted the data inactivity timer.

When the base station receives data from the terminal, the base station may use a data inactivity timer with a value corresponding to the second time period. The base station may receive data transmitted through the uplink from the terminal until the second time period elapses. However, when the base station transmits data to the terminal, the base station may use a data inactivity timer with a timer value configured as the first time period. When the base station transmits data to the terminal, the base station may transmit data only during the first time period.

A method may be proposed where an RTT between the terminal and the base station at the time the terminal starts or restarts the data inactivity timer is added to the existing data inactivity timer time period (e.g. the first time period) to configure a new time period (e.g. the second time period) as a time period of the data inactivity timer. The base station may assume that the terminal uses a value (e.g. the second time period) obtained by adding the RTT between the terminal and the base station to the existing data inactivity timer time period (e.g. the first time period) as the terminal's new data inactivity timer value at the time when the base station expects the terminal to start or restart the data inactivity timer. Accordingly, the base station may assume that the terminal does not enter the idle state at the anticipated expiration time of the terminal's data inactivity timer.

The base station may assume that the data inactivity timer expires after the second time period elapses from the time the base station anticipates the data inactivity timer to start or restart. If the second time period elapses after the time the base station anticipates the terminal's data inactivity timer to start or restart, the base station may assume that the terminal has entered the idle state due to the expiration of the data inactivity timer. If the base station assumes that the terminal has entered the idle state, the base station performs an RRC release or RRC parameter initialization. The terminal may perform data transmission and reception with the base station during the second time period after the terminal starts or restarts the data inactivity timer. If data transmission or reception occurs with the base station, the terminal may restart the data inactivity timer. When the terminal restarts the data inactivity timer, a timer value corresponding to the second time period may be set to the data inactivity timer.

The aforementioned reception window extension method may also be applied to the terminal. The terminal may determine the second time period each time the data inactivity timer is started or restarted. The terminal may configure the second time period as a timer value for the data inactivity timer. If the second time period elapses from a time data reception occurs, the terminal may notify the upper layer of the expiration of the data inactivity timer. The terminal that has notified the upper layer of the expiration of the data inactivity timer may enter the idle state. If data transmission or reception is monitored before the second time period elapses, the terminal may restart the data inactivity timer.

When receiving data from the base station, the terminal may use a data inactivity timer with a timer value corresponding to the second time period. The terminal may receive data transmitted from the base station through the downlink until the second time period elapses. However, when the terminal transmits data to the base station, the terminal may use a data inactivity timer with a value corresponding to the first time period. When transmitting data to the base station, the terminal may transmit data only during the first time period.

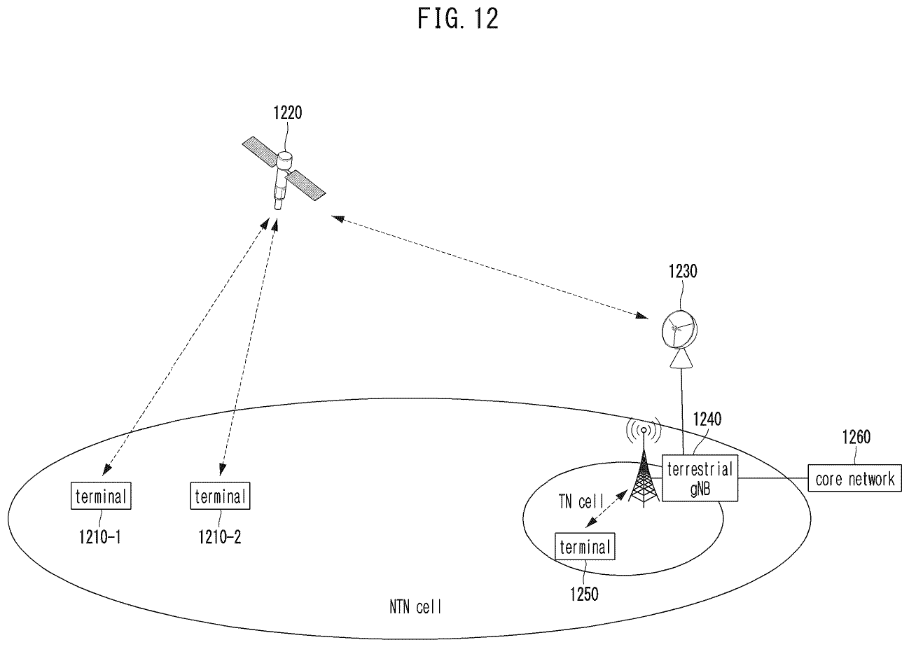

FIG. 12 is a conceptual diagram illustrating exemplary embodiments of a non-terrestrial network in which a method for compensating propagation delay using RTT is applied.

Referring to FIG. 12, a non-terrestrial network may include terminals 1210-1 and 1210-2 belonging to an NTN cell, a terminal 1250 belonging to a TN cell, a satellite 1220, a gateway 1230, a base station 1240, and a core network 1260.

It can be confirmed that the terminals 1210-1, 1210-2, and 1250 are located in the NTN cell and TN cell, respectively. A common data inactivity timer time period may be configured for all terminals 1210-1 and 1210-2 connected to the satellite. A reception window of each of the terminals 1210-1, 1210-2, and 1250 may be extended by applying a unique terminal-to-base station RTT of each terminal 1210-1, 1210-2, or 1250. The common data inactivity timer time period may be directly applied to the terminal 1250 belonging to the TN cell. In other words, the terminal 1250 belonging to the TN cell may set the terminal-to-base station RTT value to zero. Therefore, the reception window extension may not be applied to the terminal 1250 belonging to the TN cell. For each of the terminals 1210-1 and 1210-2 belonging to the NTN cell, the reception window extension using the terminal-to-base station RTT may be applied. Each of the terminals 1210-1 and 1210-2 belonging to the NTN cell may use the terminal-to-base station RTT at a time closest to a time when the data inactivity timer expires. Each of the terminals 1210-1 and 1210-2 belonging to the NTN cell may configure the second time period, which is a sum of the existing data inactivity timer time period and the terminal-to-base station RTT, as a time period for the data inactivity timer. Each of the terminals 1210-1 and 1210-2 belonging to the NTN cell may enter the idle state when the second time period elapses in accordance with the expiration of the data inactivity timer.

The methods according to the present disclosure may be implemented in the form of program instructions that can be executed through various computer means and recorded on a computer-readable medium. The computer-readable medium may include program instructions, data files, and data structures, either alone or in combination. The program instructions recorded on the computer-readable medium may be specifically designed and configured for the present disclosure or may be those that are publicly known and available to those skilled in the art of computer software.

Examples of computer-readable media include hardware devices specifically configured to store and execute program instructions, such as Read-Only Memory (ROM), Random-Access Memory (RAM), and flash memory. Examples of program instructions include machine code created by a compiler as well as high-level language code that can be executed by a computer using an interpreter or the like. The aforementioned hardware devices may be configured to operate as at least one software module to perform the operations of the present disclosure, and vice versa.

Although exemplary embodiments have been described with reference to the foregoing, those skilled in the art will understand that various modifications and changes can be made to the present disclosure without departing from the spirit and scope of the present disclosure as set forth in the claims below.

What is claimed is:

1. A method of a terminal, comprising:
transmitting first data to a base station through a satellite;
starting a data inactivity timer that expires after a first time period elapses from a time of transmitting the first data; and
determining a first round trip time (RTT) between the terminal and the base station before the first time period elapses,
wherein the data inactivity timer is configured in the terminal so that an operating state of the terminal transitions to an idle state.

2. The method according to claim 1, wherein the first RTT is determined based on at least one of a second RTT between the terminal and the satellite, a third RTT between the satellite and a reference point, or a fourth RTT between the reference point and the base station.

3. The method according to claim 2, further comprising: receiving information related to the fourth RTT from the base station, before determining the first RTT.

4. The method according to claim 1, further comprising: performing a monitoring operation for receiving second data from the base station through the satellite during a second time period that is a sum of the first time period and the first RTT.

5. The method according to claim 4, wherein when the second data is not received from the base station during the second time period, the operating state of the terminal transitions to an idle state.

6. The method according to claim 4, further comprising: restarting the data inactivity timer, when the second data is received from the base station during the second time period.

7. The method according to claim 4, further comprising:
transmitting third data to the base station before the second time period elapses; and
restarting the data inactivity timer after transmitting the third data.

8. The method according to claim 2, further comprising:
receiving information related to the third RTT from the base station, before determining the first RTT; and
assuming a type of the satellite based on the information related to the third RTT,
wherein the type of the satellite is one of a transparent type or a regenerative type.

9. A method of a base station, comprising:
receiving, from a terminal that has started a data inactivity timer, first data through a satellite;
assuming a time of receiving the first data as a start time of the data inactivity timer; and
determining a first round trip time (RTT) between the terminal and the base station,
wherein the data inactivity timer is assumed by the base station to expire after a first time period elapses from the time of receiving the first data.

10. The method according to claim 9, further comprising: assuming that an operating state of the terminal has transitioned to an idle state, when second data is not transmitted to the terminal before a second time period elapses from the time of receiving the first data, the second time period being a sum of the first time period and the first RTT.

11. The method according to claim 9, further comprising: assuming that the terminal has restarted the data inactivity timer, when second data is transmitted to the terminal before the first time period elapses from the time of receiving the first data.

12. The method according to claim 9, further comprising:
receiving third data from the terminal before a second time period elapses from the time of receiving the first data, the second time period being a sum of the first time period and the first RTT; and
assuming that the terminal has restarted the data inactivity timer after receiving the third data.

13. The method according to claim 9, further comprising: before the receiving of the first data, transmitting, in a broadcast manner, at least one of ephemeris information of the satellite, information related to a third RTT between the satellite and a reference point, or information related to a fourth RTT between the reference point and the base station.

14. The method according to claim 9, further comprising: in response to assuming that the operating state of the terminal has transitioned to an idle state, resetting one or more radio resource control (RRC) parameters for the terminal.

15. The method according to claim 9, wherein the first RTT is determined based on at least one of a second RTT between the terminal and the satellite, a third RTT between the satellite and a reference point, or a fourth RTT between the reference point and the base station.

16. The method according to claim 13, further comprising: causing the terminal to assume a type of the satellite based on the information related to the third RTT transmitted in the broadcast manner,
wherein the type of the satellite is one of a transparent type or a regenerative type.

17. A terminal comprising at least one processor, wherein the at least one processor causes the terminal to perform:
transmitting first data to a base station through a satellite;
starting a data inactivity timer that expires after a first time period elapses from a time of transmitting the first data; and
determining a first round trip time (RTT) between the terminal and the base station before the first time period elapses,
wherein the data inactivity timer is configured in the terminal so that an operating state of the terminal transitions to an idle state.

18. The terminal according to claim 17, wherein the first RTT is determined based on at least one of a second RTT between the terminal and the satellite, a third RTT between the satellite and a reference point, or a fourth RTT between the reference point and the base station.

19. The terminal according to claim 18, wherein the at least one processor further causes the terminal to perform: receiving information related to the fourth RTT from the base station, before determining the first RTT.

20. The terminal according to claim 17, wherein the at least one processor further causes the terminal to perform: performing a monitoring operation for receiving second data from the base station through the satellite during a second time period that is a sum of the first time period and the first RTT.
